(19) United States
(12) Patent Application Publication
(10) Pub. No.: US 2010/0300564 A1
(43) Pub. Date: Dec. 2, 2010

(54) AMMONIA APPLICATION SYSTEM INCLUDING AN AMMONIA DIVIDING MANIFOLD WITH VAPOR STRIPPER VENTURI

(76) Inventor: David P. Ward, Dallas, TX (US)

Correspondence Address: Daniel V. Thompson;The Law Offices Of Daniel V. Thompson P.C., 9304 Forest Lane,, Suite N253, Dallas, TX, 75243, US

(21) Appl. No.: 12/476,469

(22) Filed: Jun. 2, 2009

(51) Int. Cl. F16K 24/00

(52) U.S. Cl. 137/588

(57) ABSTRACT

An ammonia distribution system has a source of a mixed stream of ammonia liquid and vapor, and a vapor stripper located upstream of dividing structure within an ammonia dividing manifold.

### BACKGROUND OF THE INVENTION

The present invention relates in general to ammonia fertilizer application systems for agricultural use. More specifically, but without restriction to the particular use which is shown and described, this invention relates to an ammonia application system having a dividing manifold with a vapor stripper upstream of the manifold dividing structure.

The typical electronically-controlled ammonia application system consists of a nurse tank trailed behind a tool bar which is attached to a tractor. A computer console is mounted accessible to the tractor operator.

The typical mechanical ammonia application system is about the same as the electronic system, however it utilizes a manually-adjustable mechanical meter.

The nurse tank is a trailer-mounted pressure vessel which contains the ammonia in its liquid state. The liquid withdrawal valve is mounted at the top of the tank and has a dip tube which extends to the bottom of the tank. A suitable hose connects this valve to a filter connected to a main shutoff valve mounted on the tool bar. The ammonia then flows through a heat exchanger unit, then through a meter, then to an electronically controlled throttling valve, then to one or more dividing manifolds, and finally through suitable hoses to the applicator knives which inject the ammonia into the soil.

As the liquid ammonia enters the dip tube located at the bottom of the tank, its thermodynamic conditions begin to change. The ammonia begins to expand. This results in the formation of ammonia vapor within the system which must be removed by a heat exchanger unit prior to metering in order to assure a properly-measured quantity of ammonia to the applicator knives and into the soil.

These systems work fairly well, but under certain conditions problems can arise. Crops such as corn require more than twice the amount of ammonia per acre than the smaller grain crops. The greater expansion of the ammonia across the total system often forms more vapor than the typical heat exchanger unit can handle.

The large food producers of the world with its increasing population can no longer afford the present inefficient anhydrous ammonia management systems. The proper management of the ammonia requires it to be in its liquid state as it crosses its metering devices and dividing manifolds.

It would be a distinct advantage to have an ammonia dividing manifold device which would provide the means necessary to reduce the volume of the ammonia within the system to a state of total liquid prior to dividing, which would provide for greater control and application accuracy. The present invention provides such a unit.

### SUMMARY OF THE INVENTION

An ammonia distribution system has a source of a mixed stream of ammonia liquid and vapor, and a vapor stripper located upstream of dividing structure within an ammonia dividing manifold.

### BRIEF DESCRIPTION OF THE DRAWINGS

A more complete understanding of the invention and its advantages will be apparent from the Detailed Description taken in conjunction with the accompanying Drawings, in which:

FIG. 1 is a plan view of the ammonia application system of the present invention;

FIG. 2 is an enlarged portion of FIG. 1;

FIG. 3 is a top view of the ammonia dividing manifold used in the invention;

FIG. 4 is a side view of the ammonia dividing manifold;

FIG. 5 is an exploded view of the ammonia dividing manifold; and

FIG. 6 is a sectional view taken along lines 6-6 of FIG. 3.

### DETAILED DESCRIPTION

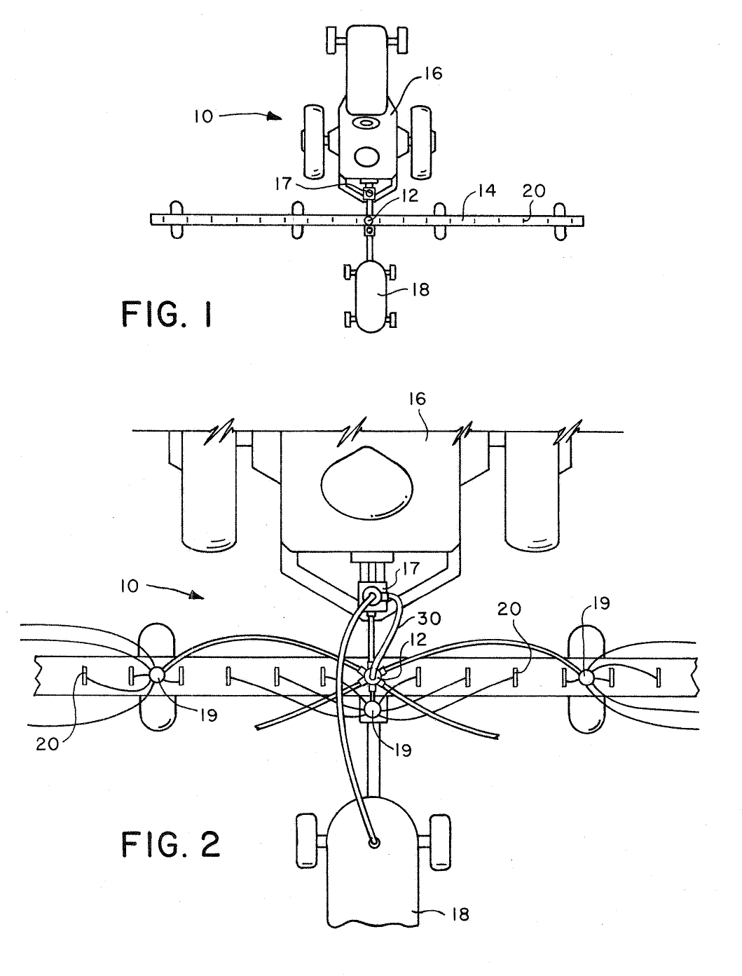

Referring initially to FIGS. 1 and 2, where like numerals refer to like and corresponding parts, an ammonia distribution system 10 includes an ammonia manifold 12 mounted on tool bar 14. Tractor 16 pulls the tool bar 14 and the ammonia nurse tank 18 in conventional fashion. A meter 17 receives ammonia from the tank 18, then metered ammonia flows to ammonia dividing manifold 12, is divided, and then the divided flows are then further divided in sub-manifolds 19 connected to knives 20 on tool bar 14. Knives 20 inject precisely-metered and accurately-divided streams of ammonia liquid and vapor into the soil as the tractor traverses an agricultural field.

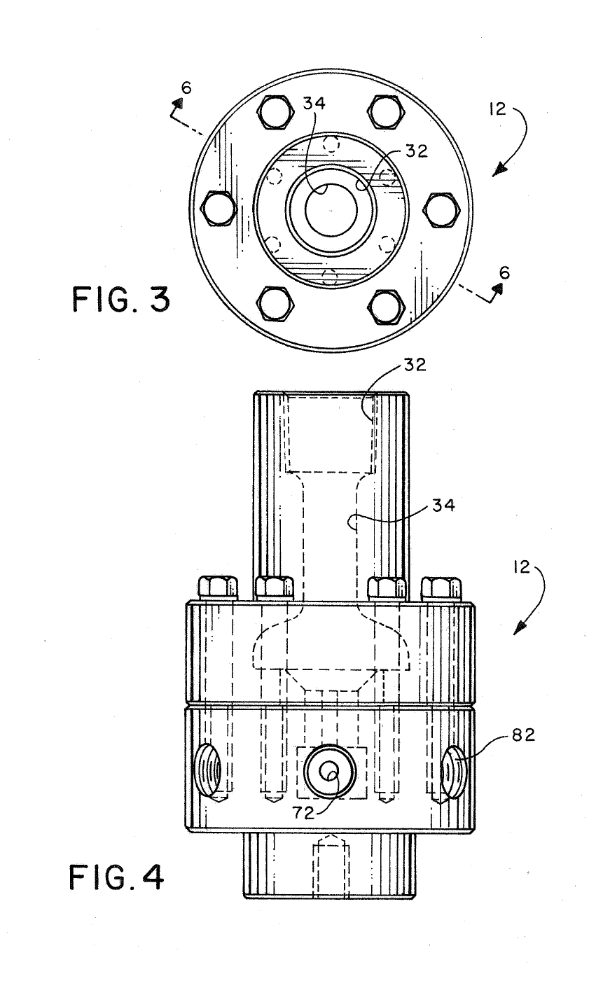

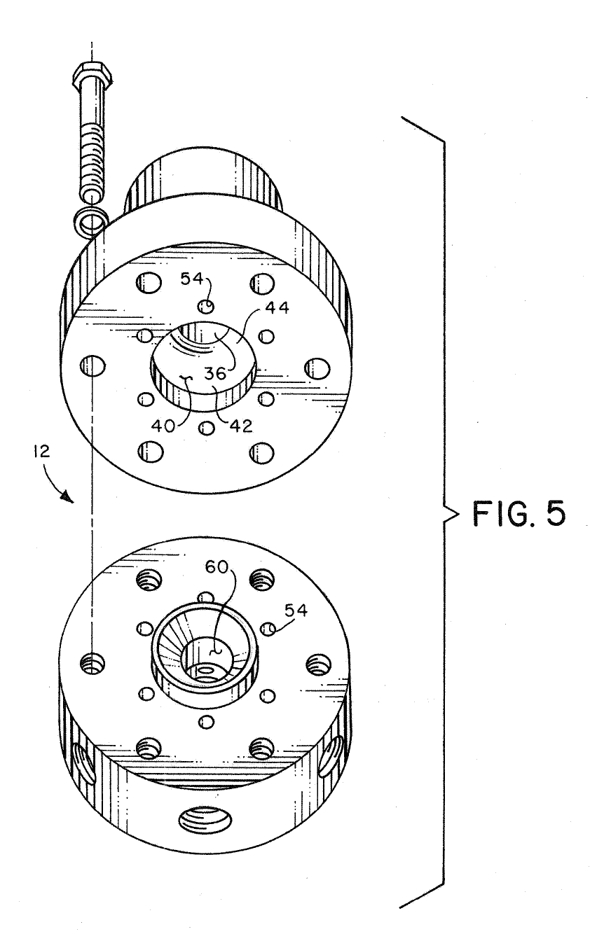

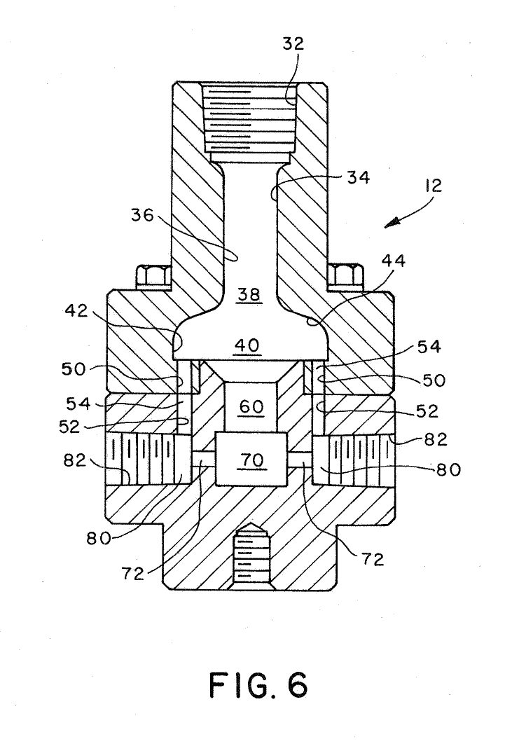

The present invention is primarily focused on ammonia dividing manifold 12, which is shown in detail in FIGS. 3-6, where like numerals refer to like and corresponding parts. An inlet conduit 30 (FIG. 2) is connected between manifold 12 and a source of ammonia, which in this system is meter 17 Inlet conduit 30 is located downstream of the source of ammonia.

A manifold inlet 32 is located downstream of the inlet conduit 30 to receive a mixed stream of ammonia liquid and vapor from the source of ammonia by way of the inlet conduit 30.

The manifold inlet 32 connected to an internal nozzle 34 within the manifold 12. Internal nozzle 34 having a nozzle exit wall 36 defining an opening 38 with a first cross-sectional area for ejecting the mixed stream of ammonia liquid and vapor received from the manifold inlet 32.

A vapor stripper venturi chamber 40 is provided within the manifold downstream of the nozzle exit opening 38 for receiving the mixed stream ejected from the nozzle exit opening 38. The vapor stripper venturi chamber 40 has a venturi wall 42 defining a second cross-sectional area about nine times larger than the first cross-sectional area of the nozzle exit opening 38. Where the walls 42 and 36 are cylindrical, the diameters have a ratio of about 3:1, and thus the cross-sectional areas a ratio of about 9:1. Some variation of these ratios is within the scope of the invention, and the precise limits under varying conditions may be readily determined by routine experimentation. Venturi wall 42 is connected to the nozzle exit wall 38 by a transition wall 44.

Walls 50 and 52 form multiple vapor exit conduits 54 located proximate the venturi wall 42.

A liquid receiver passageway 60 is connected to the venturi chamber 40 positioned to receive liquid ammonia ejected from the nozzle exit opening 38 stripped of vapor.

Dividing structure 70 is connected to the liquid receiver passageway 60 and has multiple liquid exit conduits 72. The dividing structure is adapted and arranged to divide the liquid ammonia into multiple streams of liquid, one stream in each of the multiple liquid exit conduits 72.

A remix chamber 80 associated with each one of multiple outlets 82 of the manifold. Each remix chamber 80 is connected to one of the multiple liquid exit conduits 72 from the dividing structure 70 and one of the multiple vapor exit conduits 54 from the venturi chamber 40.

It will be understood that each of the elements described above, or two or more together, may also find a useful application in other types of constructions differing from the type described above.

While the invention has been illustrated and described as embodied in a particular ammonia application system, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

I claim:

1. An ammonia distribution system, comprising: a source of a mixed stream of ammonia liquid connected to an ammonia dividing manifold, and a vapor stripper located upstream of dividing structure within the ammonia dividing manifold.

2. The ammonia distribution system of claim 1, with the vapor stripper including an internal nozzle within the manifold, the internal nozzle having a nozzle exit wall defining an opening with a first cross-sectional area for ejecting the mixed stream of ammonia liquid and vapor received from a manifold inlet.

3. The ammonia distribution system of claim 2 ammonia dividing manifold with a vapor stripper venturi chamber within the manifold downstream of the nozzle exit opening for receiving the mixed stream ejected from the nozzle exit opening, the vapor stripper venturi chamber having a venturi wall defining a second cross-sectional area.

4. The ammonia distribution system of claim 3 with the second cross-sectional area of the venturi chamber being about nine times larger than the first cross-sectional area of the nozzle exit opening.

5. The ammonia distribution system of claim 3 with the venturi wall being connected to the nozzle exit wall by a transition wall.

6. The ammonia distribution system of claim 3 with walls forming multiple vapor exit conduits located proximate the venturi wall.

7. The ammonia distribution system of claim 3 with a liquid receiver passageway connected to the venturi chamber positioned to receive liquid ammonia ejected from the nozzle exit opening stripped of vapor.

8. The ammonia distribution system of claim 3 with:
dividing structure connected to the liquid receiver passageway and having multiple liquid exit conduits, the dividing structure being adapted and arranged to divide the liquid ammonia into multiple streams of liquid, one stream in each of the multiple liquid exit conduits; and
a remix chamber associated with each one of multiple outlets of the manifold, each remix chamber being connected to one of the multiple liquid exit conduits from the dividing structure and one of the multiple vapor exit conduits from the venturi chamber.

9. An ammonia distribution system including an ammonia manifold with vapor stripper venturi, the ammonia distribution system comprising:
an inlet conduit connected to a source of ammonia, the inlet conduit located downstream of the source of ammonia;
a manifold inlet located downstream of the inlet conduit to receive a mixed stream of ammonia liquid and vapor from the source of ammonia by way of the inlet conduit;
the manifold inlet connected to an internal nozzle within the manifold, the internal nozzle having a nozzle exit wall defining an opening with a first cross-sectional area for ejecting the mixed stream of ammonia liquid and vapor received from the manifold inlet;
a vapor stripper venturi chamber within the manifold downstream of the nozzle exit opening for receiving the mixed stream ejected from the nozzle exit opening, the vapor stripper venturi chamber having a venturi wall defining a second cross-sectional area about nine times larger than the first cross-sectional area of the nozzle exit opening, the venturi wall being connected to the nozzle exit wall by a transition wall;
walls forming multiple vapor exit conduits located proximate the venturi wall;
a liquid receiver passageway connected to the venturi chamber positioned to receive liquid ammonia ejected from the nozzle exit opening stripped of vapor;
dividing structure connected to the liquid receiver passageway and having multiple liquid exit conduits, the dividing structure being adapted and arranged to divide the liquid ammonia into multiple streams of liquid, one stream in each of the multiple liquid exit conduits; and
a remix chamber associated with each one of multiple outlets of the manifold, each remix chamber being connected to one of the multiple liquid exit conduits from the dividing structure and one of the multiple vapor exit conduits from the venturi chamber.
